(19) United States
(12) Patent Application Publication
(10) Pub. No.: US 2005/0148376 A1
(43) Pub. Date: Jul. 7, 2005

(54) Integrated gaming capability in vehicle entertainment systems

(76) Inventor: Curtis C. Kucera, Temecula, CA (US)

Correspondence Address: KOLISCH HARTWELL, P.C., 520 S.W. YAMHILL STREET, SUITE 200, PORTLAND, OR, 97204, US

(21) Appl. No.: 11/026,338

(22) Filed: Dec. 29, 2004

Related U.S. Application Data
(63) Continuation-in-part of application No. 10/818,867, filed on Apr. 5, 2004.
Application No. 10/818,867 is a continuation of application No. 09/851,695, filed on May 8, 2001, now abandoned.
(60) Provisional application No. 60/206,590, filed on May 23, 2000.
(60) Provisional application No. 60/536,165, filed on Jan. 12, 2004.

(51) Int. Cl. A63F 13/00

(52) U.S. Cl. 463/1

(57) ABSTRACT

A vehicle entertainment system is provided, the system including a housing, a video module at least partially contained within the housing and configured to selectively provide video content, a game module at least partially contained within the housing and configured to selectively provide game content, a content selector configured to receive content from the video module and the game module and to selectively pass such content under user direction, and a presentation module in operative communication with the content selector to receive content passed by the content selector and to present the passed content to the user.

### CROSS-REFERENCE TO RELATED APPLICATIONS

This application claims priority from U.S. Provisional Patent Application Ser. No. 60/536,165, filed Jan. 12, 2004 for a SYSTEM AND METHOD FOR INTEGRATING GAMING CAPABILITY IN VEHICLE ENTERTAINMENT SYSTEMS. U.S. Provisional Patent Application Ser. No. 60/536,165 is incorporated herein by this reference thereto.

This application is a continuation-in-part of U.S. patent application Ser. No. 10/818,867 of Mark A. Cook, Terrence S. Melvin and Charles A. Paul Jr. for a CEILING-MOUNTED MONITOR SYSTEM, filed Apr. 5, 2004, which is a continuation of U.S. patent application Ser. No. 09/851,695 of Mark A. Cook, Terrence S. Melvin and Charles A. Paul Jr. for a CEILING MOUNTED MONITOR SYSTEM, filed May 8, 2001, and which claims priority to U.S. Provisional Patent Application Ser. No. 60/206,590 of Mark A. Cook, Terrence S. Melvin and Charles A. Paul Jr. for a CEILING-MOUNTED VIDEO DISPLAY SYSTEM WITH SIDE-BY-SIDE MONITOR AND VIDEO SOURCE, filed May 23, 2000. U.S. patent application Ser. No. 10/818,867 is incorporated herein by this reference thereto.

### TECHNICAL FIELD

The present invention relates generally to vehicle entertainment systems, and more particularly, to vehicle entertainment systems which integrate video and gaming capabilities.

### BACKGROUND

In recent years, onboard entertainment systems have become increasingly popular additions to vehicles. Until fairly recently, these vehicle entertainment systems have provided little more than pre-recorded video content to passengers. Gaming typically has not been available in vehicles, and where gaming has been available, it has been available only via a separate and independent game console.

Using an independent game console in a vehicle is problematic for a variety of reasons. For example, game consoles typically are bulky, but nonetheless require placement in a vehicle where space for electronic components is at a premium. Where various forms of onboard entertainment are desired, interior space for the corresponding electronic components can quickly become unavailable.

Another problem relates to connectivity between the various onboard electronic components, which generally is achieved via hardwire connections. These hardwire connections between components can become intrusive to passengers where components are placed variously within the passenger seating area, and may be especially undesirable in the context of a moving vehicle.

Furthermore, because most conventional game consoles are designed specifically for home use and operate on household voltage (115 VAC), use of such game modules in a vehicle may require the addition of yet another component to convert the available vehicle voltage (from 12 VDC to 115 VAC).

Nevertheless, gaming remains a potentially important addition to vehicle entertainment systems because it provides entertainment value beyond passively watching pre-recorded video programming. Gaming also offers variety that heretofore has not been available in vehicle entertainment. Entertainment systems that provide video programming, for example, generally are tailored to a two-to-three hour viewing period (based upon the average length of a movie), making conventional vehicle entertainment systems most practical for use only during extended trips. Gaming, on the other hand, may provide an entertainment experience suitable for trips having durations of from seconds to minutes to hours. By providing an entertainment system that combines video programming with gaming, an entertainment experience may be achieved that is suitable for all forms and durations of vehicle travel.

### BRIEF DESCRIPTION OF THE DRAWINGS

FIG. 1 is a perspective view of a vehicle entertainment system constructed in accordance with an embodiment of the present invention.

FIG. 2 is a side view of the vehicle entertainment system of FIG. 1, mounted on the ceiling of a vehicle.

FIG. 3 is a schematic view illustrating architecture of the vehicle entertainment system of FIG. 1.

FIG. 4 is a schematic view illustrating architecture of a vehicle entertainment system constructed in accordance with a first alternative embodiment of the present invention.

FIG. 5 is a schematic view illustrating architecture of a vehicle entertainment system constructed in accordance with a second alternative embodiment of the present invention.

### DETAILED DESCRIPTION

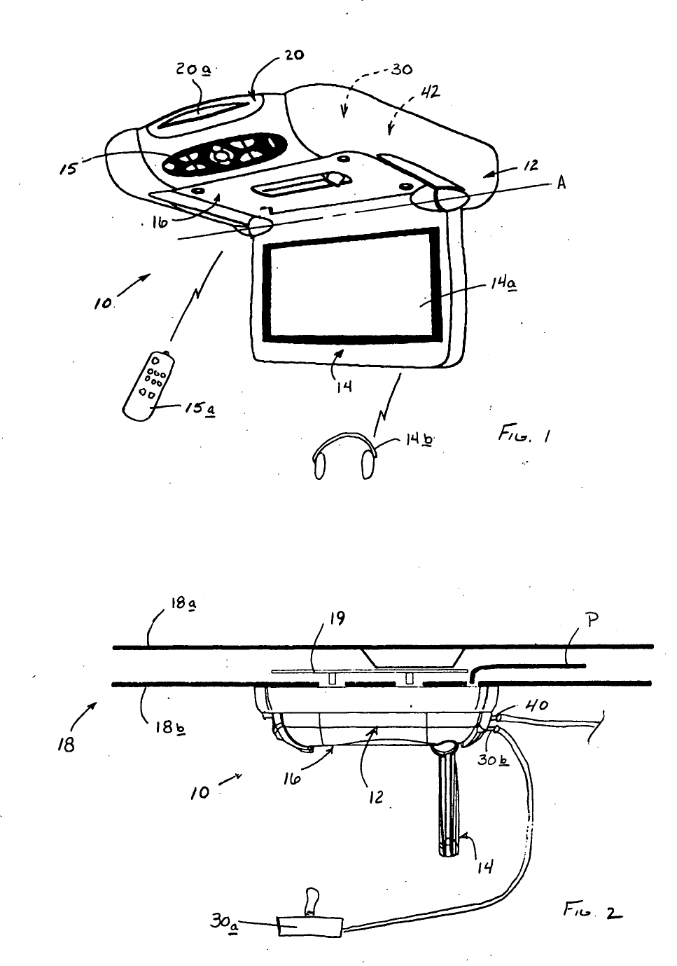

A vehicle entertainment system according to an embodiment of the present invention is shown generally at 10 in FIG. 1, the system including a housing 12, which may be mounted centrally to the ceiling of an automobile. Although the present vehicle entertainment system 10 generally is discussed herein as being mounted to an automotive ceiling, it is to be understood that the vehicle entertainment system is suitable for use in any of a variety of vehicles, and in any of a variety of mounting configurations.

As indicated, the vehicle entertainment system includes a presentation module 14, which may be configured to present audio and video to occupants of the automobile. A direct view display screen 14a may be employed to selectively present video images to the occupants. Headphones 14b (or automotive speakers) may be employed to selectively present audio to the occupants.

A control panel 15, and/or a remote control device 15a, directs various operations of the vehicle entertainment system. More particularly, control panel 15 (and/or remote control device 15a) may be configured to allow vehicle occupants to select from various sources (e.g., a DVD source, a gaming source, a tuner source, etc.), and to direct presentation of the corresponding content by the presentation module. Although not specifically shown in FIG. 1, it will be appreciated that the control panel may direct operation of the entertainment system by communication with a system processor, and/or with an audio/video multiplexer.

In the present embodiment, display screen 14 is configured to pivot about an axis A, between a deployed orientation (shown in FIG. 1) wherein the display screen is viewable by rear seat passengers of the automobile, and a stowed orientation wherein the display screen generally parallels the lower surface of the housing (and the automotive ceiling to which the housing is attached). In some embodiments, the housing may define a display recess 16 configured to receive the display screen when in the stowed orientation. In this manner, the vehicle entertainment system may be configured to minimize intrusion into the passenger area when the system is not in use.

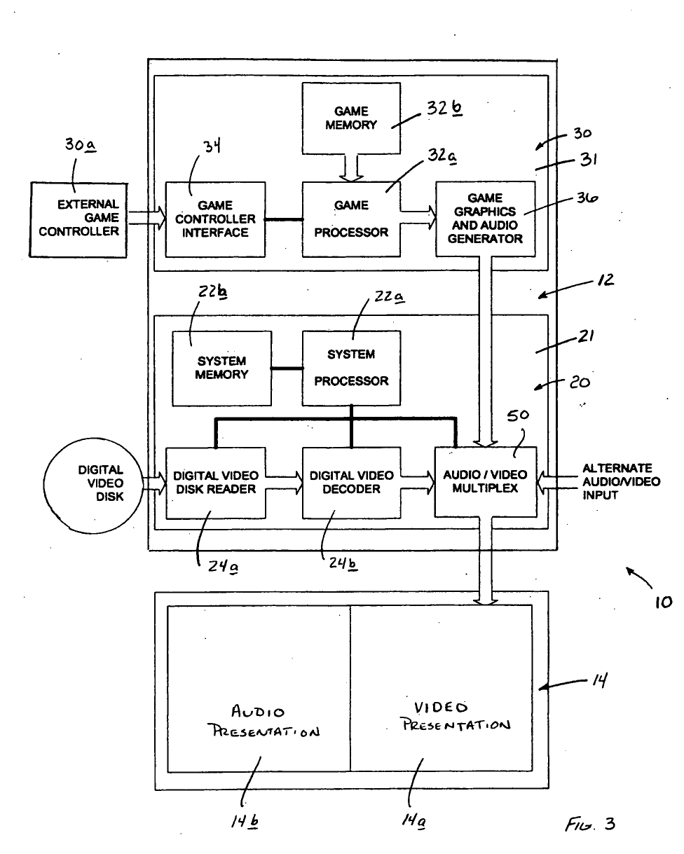

FIG. 2 illustrates mounting of the vehicle entertainment system to an automotive ceiling 18. Although various mounting arrangements are possible, the depicted vehicle entertainment system employs a bracket 19, which may be fastened to a beam (or beams) of roof 18a. The bracket may form a part of an entertainment system frame, or may be fastened to the entertainment system frame so as to sandwich an automotive headliner 18b between the bracket and the entertainment system frame, as shown in FIG. 2. In this configuration, cabling in the passenger area may be reduced by running power cable P (and other cabling connections) within the ceiling, in an area between the automotive headliner and the roof.

Although not immediately apparent from FIGS. 1 and 2, it will be appreciated that the vehicle entertainment system includes a video module 20 configured to provide video content to display screen 14, and a game module 30 configured to provide game content to display screen 14. Both video module 20 and game module 30 may form integral parts of the vehicle entertainment system, and typically are substantially contained within housing 12 so as to minimize intrusion into the passenger seating area of the vehicle.

Video module 20 may be provided with video content via prerecorded media, such as digital video disks (DVDs) memory cards, etc. The video module thus typically defines a media port 20a, which receives media through housing 12. An onboard media reader selectively reads the media, and transmits the corresponding data to a decoder for production of audio/video signals. In some embodiments, the media reader may actually take the form of a wireless receiver whereby video content may be received from a remote source via a wireless communication link.

In contrast to video module 20, game module 30 may be configured to generate game content internally, without any insertion of separate game cartridges, or the like. Rather, games may be stored in memory for access by a game processor, which manages operation and presentation of the game. Alternatively, or additionally, games may be recorded on DVDs, memory cards, or other memory devices, and selectively loaded via the onboard media reader (or a similar dedicated game reader). In some embodiments, games may be downloaded to game memory via the game reader, or via a wired or wireless communications link.

The game module also may employ a game controller 30a, which communicates with the game module via a gaming control input jack 30b when the gaming feature of vehicle entertainment system 10 is in use. Although a wired communication link is shown, it will be understood that the game controller may communicate wirelessly with the game module, for example, using IR or RF communications. It also will be understood that the game controller may be integral with remote control device 15a, providing for control of both the video module and the game module with a single control device. Furthermore, the game controller may incorporate the game reader, and thus may provide for download of a game.

One or more audio/video input jacks 40 (FIG. 2) also may be employed, providing an input for audio/video signals from external video sources such as television tuners, portable video players, camcorders, or the like. Selection and operation of such external sources may be controlled using control panel 15, or using a remote control device capable of communicating with the external sources via the vehicle entertainment system.

In some embodiments, the vehicle entertainment system may employ a tuner module 42, which receives broadcast television signals via an antenna (not shown). The tuner module may be integral with vehicle entertainment system 10, and substantially contained within housing 12. More typically, however, the tuner will be positioned external to the housing in a location which minimizes unnecessary use of space in the passenger compartment, and maximizes signal reception. Where the tuner is a semi-permanent fixture, the tuner may provide an audio/video signal to display screen 14 via cabling within ceiling 18. Alternatively, the tuner may provide an audio/video signal to the display screen via cabling to audio/video input jacks 40.

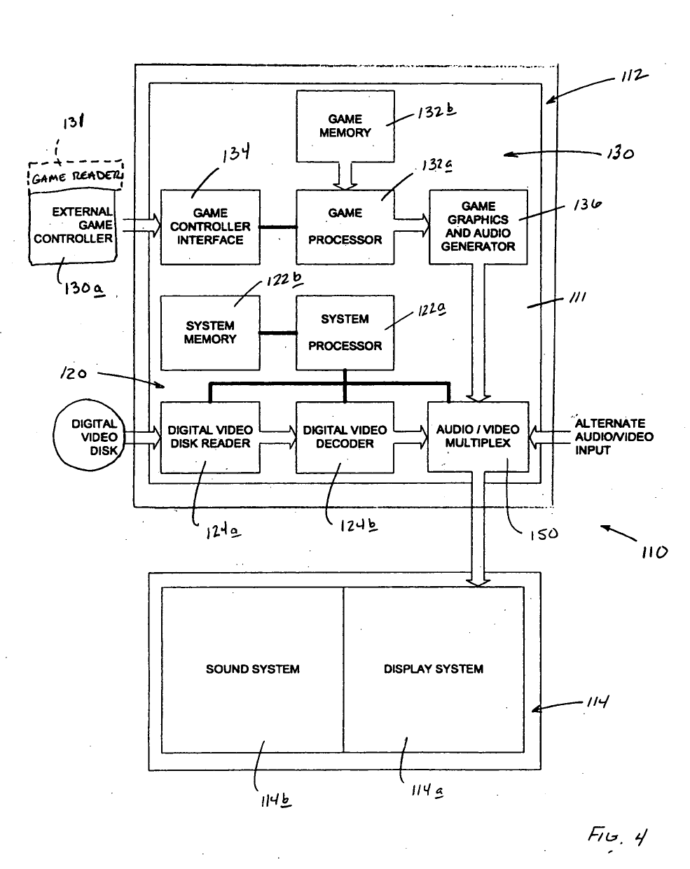

Turning now to FIG. 3, exemplary architecture of vehicle entertainment system 10 is illustrated, the vehicle entertainment system including a video module 20 and a game module 30, both of which are substantially contained within housing 12. Video module 20 is disposed on a video circuit board 21. Game module 30 is disposed on a game circuit board 31. Each module selectively produces audio/video signals for communication to the display screen. An audio/video multiplexer 50 may be provided to manage traffic to a presentation module 14.

As indicated, video circuit board 21 typically carries a system processor 22a and system memory 22b. Audio/video multiplexer 50 also may be resident on video circuit board 21. The audio/video multiplexer receives audio/video signals from each of the audio/video sources (e.g., video module 20, game module 30, and audio/video input jack 40), and selects an audio/video signal under direction of the system processor for communication to presentation module 14. The system processor, in turn, may be directed by a system user via a control device, such as remote control device 15a (FIG. 1).

System processor 22a also may direct operation of the video module, including operation of a digital video disk reader 24a and a digital video decoder 24b, both of which may be disposed on video circuit board 21. Digital video disk reader 24a may be configured to receive a digital video disk (DVD), as shown, and to read the audio/video content on such disk. The video content may be communicated to digital video decoder 24b, where it is decoded to place such content in a form suitable for presentation by presentation module 14. A corresponding audio/video signal thus may be passed to audio/video multiplexer 50.

It will be appreciated that, although a digital video disk reader is shown in FIG. 3, any of a variety of different video input devices may be employed, including a memory card reader, a video cassette player, etc. Furthermore, a video decoder may or may not be necessary, depending on the format of video input.

Game circuit board 31 typically carries a game processor 32a and game memory 32b. The game processor typically is configured to download a game from game memory (or from another game source), and to direct operation and presentation of such game. In particular, the game processor implements control signals received from a game control interface 34 on the gaming circuit board. The game control interface receives control directives from the external game controller 30a, and the external game controller is controlled by a user. In view of these control directives, the game processor generates game data (also referred to as game content) and passes such game data on to a game graphics and audio generator 36 on the game circuit board. The game graphics and audio generator generates an audio/video signal, and communicates such audio/video signal to audio/video multiplexer 50. As noted previously, the external game controller also may include a game reader, whereby games may be downloaded. Alternatively, games may be downloaded from an auxiliary source (not shown).

The audio/video multiplexer selectively communicates an audio/video signal (whether produced by the video module, the game module, or some other audio/video signal source) to presentation module 14. Such communication is under direction of the system processor, based on control directives by the user. A video presentation device 14a of presentation module 14 presents the video component of the audio/video signal. An audio presentation device 14b of presentation module 14 presents the audio component of the audio/video signal (generally via headphones or automotive speakers in communication with the audio presentation device via a wired or wireless communication link).

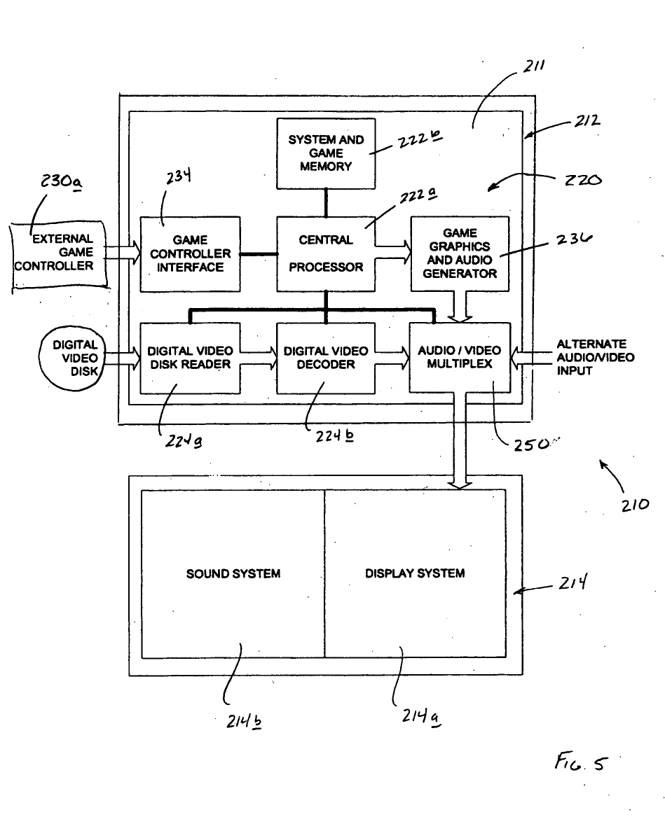

FIG. 4 shows a first alternative to the exemplary architecture of FIG. 3. In FIG. 4, a vehicle entertainment system 110 is illustrated, the vehicle entertainment system including a video module 120 and a game module 130, both substantially contained in a housing 112. However, unlike vehicle entertainment system 10, vehicle entertainment system 110 places both the video module and the game module on a single, unitary video/game circuit board 111.

Accordingly, video/game circuit board 111 typically carries a system processor 122a and system memory 122b. System processor 122a directs operation of the video module, including operation of a digital video disk reader 124a and a digital video decoder 124b. Digital video disk reader 124a may be configured to receive a digital video disk (DVD), and to read the video content on such disk. The video content may be communicated to digital video decoder 124b, where it may be decoded. A corresponding audio/video signal may be passed to audio/video multiplexer 150, which selectively passes the audio/video signal to presentation module 114, based on control directives from the user, via system processor 122a.

Video/game circuit board 111 also carries a game processor 132a and game memory 132b. The game processor typically may download a game from game memory (or another source), and direct operation and presentation of such game based on control directives received from a game controller 130a via a game control interface 134. A user, in turn, directs game controller 130a. In view of these control directives, the game processor generates game data and passes such game data on to a game graphics and audio generator 136. The game graphics and audio generator generates an audio/video signal, and passes such audio/video signal to audio/video multiplexer 150 for selected communication to presentation module 114.

Once communicated to presentation module 114, a video presentation device 114a presents the video component of the audio/video signal, and an audio presentation device 114b presents the audio component of the audio/video signal.

In some embodiments, external game controller 130a may include an optional game reader 131. Game reader 131 may be configured to receive a game medium (such as a game cartridge), and to read the game on such game medium. The game may be communicated to the game processor 132a via game controller interface 134. The game processor, in turn, may pass game data (game content) on to game graphics and audio generator 136, where an audio/video signal is generated for selected presentation.

FIG. 5 shows a second alternative to the exemplary architecture of FIG. 3. In FIG. 5, a vehicle entertainment system 210 is illustrated, the vehicle entertainment system including an integrated video/gaming module 220 substantially contained in a housing 212. As indicated, the video/gaming module is carried on a single, unitary video/game circuit board 211.

Accordingly, video/game circuit board 211 typically carries a central processor 222a and system and game memory 222b. Central processor 222a directs operation of the vehicle entertainment system, including operation of a digital video disk reader 224a and a digital video decoder 224b, but also directs operation of and presentation of a game based on control signals received from an external game controller 230a via a game control interface 234. The game, it will be appreciated, may be downloaded from system and game memory 222b, may be received via digital video disk reader 224a, or may be received from some other game source. The central processor generates game data and passes such game data on to a game graphics and audio generator 236. Game graphics and audio processor 236 generates an audio/video signal, and passes such audio/video signal to an audio/video multiplexer 250.

Digital video disk reader 224a may be configured to receive digital video disks (DVDs), and to read either video content or games from such disks. Video content may be communicated to digital video decoder 224b, where it may be decoded. Games may be communicated to the central processor as described above. In either event, a corresponding audio/video signal may generated and be passed to audio/video multiplexer 250.

Audio/video multiplexer 250 selectively passes audio/video signals to presentation module 214, where a video presentation device 214a presents the video component of the audio/video signal, and an audio presentation device 214b presents the audio component of the audio/video signal.

By integrating gaming functionality into a vehicle entertainment system, it is possible to: (i) preserve passenger space by eliminating the need for a separate game console; (ii) use native voltages of the vehicle entertainment system, eliminating the need for a power converter; (iii) eliminate the need for a wiring harnesses to connect the game console electrically to the entertainment system; and (iv) eliminate the need for separate game cartridges (e.g. DVDs, CDs, etc.).

1. A vehicle entertainment system comprising:
a housing;
a video module at least partially contained within the housing, the video module being configured to selectively provide video content;
a game module at least partially contained within the housing, the game module being configured to selectively provide game content;
a content selector configured to receive content from the video module and the game module, and to selectively pass such content under user direction; and
a presentation module in operative communication with the content selector to receive content passed by the content selector, and to present the passed content to the user.

2. The vehicle entertainment system of claim 1, wherein the video module is disposed on a video circuit board, and wherein the game module is disposed on a game circuit board adjacent the video circuit board.

3. The vehicle entertainment system of claim 1, wherein the video module and the game module are both resident on a unitary video/game circuit board.

4. The vehicle entertainment system of claim 1, wherein the video module and the game module share a central processor.

5. The vehicle entertainment system of claim 1, wherein the video module and the game module share a memory device.

6. The vehicle entertainment system of claim 1, which further comprises a reader configured to read content from prerecorded media for selected processing and subsequent presentation by the presentation module.

7. The vehicle entertainment system of claim 1, wherein the video module includes a video reader configured to read video from prerecorded media.

8. The vehicle entertainment system of claim 7, wherein the video reader is a digital video disk reader, and wherein the video module further includes a digital video decoder configured to format video for presentation by the presentation module.

9. The vehicle entertainment system of claim 1, wherein the game module includes a game processor configured to selectively download a game, and to generate game data based on the game.

10. The vehicle entertainment system of claim 9, wherein the game module further includes a game graphics and audio generator configured to receive game data from the game processor, and to generate an audio/video signal corresponding to the game data.

11. The vehicle entertainment system of claim 9, wherein the game module further includes a game controller interface which provides for operative communication between a user and the game processor to direct generation of game data.

12. The vehicle entertainment system of claim 9, wherein the vehicle entertainment system further comprises an external game controller whereby the user communicates with the game processor to direct generation of such game data.

13. The vehicle entertainment system of claim 12, wherein the external game controller includes a game reader configured to read a game from prerecorded media, and wherein the external game controller is configured to communicate the game to the game processor.

14. The vehicle entertainment system of claim 9, wherein the game module further includes game memory which stores the game for selected download by the game processor.

15. The vehicle entertainment system of claim 1, wherein the presentation module is configured to receive content as an audio/video signal.

16. The vehicle entertainment system of claim 15, wherein the presentation module includes a video presentation device configured to present a video component of the audio/video signal.

17. The vehicle entertainment system of claim 15, wherein the presentation module includes an audio presentation device configured to present an audio component of the audio/video signal.

18. The vehicle entertainment system of claim 17, wherein the audio presentation device is a wireless headphone assembly in wireless communication with the content selector.

19. A vehicle entertainment system for use in a vehicle having a ceiling, the vehicle entertainment system comprising:
a housing configured to mount to the ceiling of the vehicle;
a video module at least partially contained within the housing, the video module including a video reader configured to read video content from prerecorded media, and to produce an audio/video signal derived from the video content;
a game module at least partially contained within the housing, the game module including a game processor configured to download a game from a game source, to generate game content from such game under user direction, and to produce an audio/video signal derived from the game content;
an audio/video multiplexer configured to receive audio/video signals from the video module and game module, and to selectively pass such content under user direction; and
a display screen pivotally deployable from the housing and in operative communication with the audio/video multiplexer to receive audio/video signals passed by the audio/video multiplexer, and to display a corresponding video component of the audio/video signal.

20. The vehicle entertainment system of claim 19, wherein the video module and game module are both resident on a single video/game circuit board.
